(19) United States
(12) Patent Application Publication
(10) Pub. No.: US 2013/0281274 A1
(43) Pub. Date: Oct. 24, 2013

(54) PLATFORM FOR EXERCISE APPARATUS AND OTHER DEVICES

(71) Applicants: Steven Joseph Ferrusi, Antioch, TN (US); Daniel Bizzell, Charlotte, NC (US)

(72) Inventors: Steven Joseph Ferrusi, Antioch, TN (US); Daniel Bizzell, Charlotte, NC (US)

(21) Appl. No.: 13/715,592

(22) Filed: Dec. 14, 2012

Related U.S. Application Data
(60) Provisional application No. 61/630,538, filed on Dec. 14, 2011.

(51) Int. Cl. F16M 13/02

(52) U.S. Cl. CPC F16M 13/022
USPC 482/148

(57) ABSTRACT

An a platform, which may also be referred to as an amenity platform, that may stand alone or be attached to a human form disposition element, such as a chair, desk, or an exercise device. Said amenity platform comprises a tray supported by a platform frame having an essentially u-shape with opposing, essentially parallel, bars extending from opposite ends of a platform frame base. One or more arm rests with pads are attached to the platform. The arms rests may roll or vibrate, providing a massaging effect. The arms rests may be movable or articulated with respect to the platform tray.

This application claims benefit of and priority to U.S. Provisional Application No. 61/630,538, filed Dec. 14, 2011, by Steven Joseph Ferrusi, and is entitled to that filing date for priority. The specification, figures and complete disclosure of U.S. Provisional Application No. 61/630,538 are incorporated herein by specific reference for all purposes.

### FIELD OF INVENTION

This invention relates to exercise facilitation. More specification, this invention relates to a platform for use with an exercise apparatus or other devices.

### BACKGROUND OF THE INVENTION

Bodily exercise is essentially universally acknowledged to be beneficial to health and well-being. Therefore, devices and regimens to facilitate same have long been devised and promoted. Especially popular are devices which are relatively small and stationary thus allowing a user to expend muscular energy while remaining in one place. Such devices may include steppers, treadmills, elliptical walkers, stationary bicycles, traditional bicycles having stands allowing them to be pedaled while remaining unmoved.

These devices are advantageous in that they allow indoor exercise regardless of non-conducive outdoor conditions such as rain, wind, lightning, extreme heat or cold, darkness, and the like. However, exercise indoors with these devices tends to be boring and time consuming. This tends to reduce frequency and duration of sessions. Also, many said devices require the user to achieve an uncomfortable posture which places disproportional strain on weaker body parts, again causing the user to end an exercise session before stronger body parts have been sufficiently taxed.

Accordingly, what is needed is an apparatus that overcomes these shortcomings.

### SUMMARY OF INVENTION

In various embodiments, the present invention comprises a platform, sometimes referred to as an amenity platform, that can stand alone or can be used with chairs, desks, exercise equipment, or other devices. In one exemplary embodiment, the present invention comprises a platform, platform frame, arm rest frame, device or equipment interface or mount, and frame interface or mount. In another embodiment, the amenity platform comprises a tray supported by a platform frame having an essentially u-shape with opposing, essentially parallel, bars extending from opposite ends of a platform frame base. One or more arm rests with pads are attached to the platform. The arms rests may roll or vibrate, providing a massaging effect, and may be of particular benefit in providing relief from the strain of typing on a computer. The arms rests may be movable or articulated with respect to the platform tray. A squeezable exercise ball or syringe may be attached to the platform.

An object of the invention is to alleviate boredom of exercise.

Another object of the invention is to permit concurrent computer use or wanted tasks along with exercise activity.

Another object of the invention is to facilitate comfort when exercising.

Another object of the invention is to facilitate ergonomic body disposition while exercising.

A further object of the invention is to minimize stress on weaker body parts so that stronger body parts may exercise longer.

Yet another object of the invention is to encourage more frequent exercise sessions. For example, providing a device such as a massage roller or exercise ball near where a computer is being used will create more frequent use.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1A is a perspective view of an embodiment of the invention.

FIG. 1B shows a side cutaway view of mounting means of the invention of FIG. 1A.

FIG. 1C shows a close-up cutaway view of a sliding attachment mechanism.

FIG. 2A is a perspective view of another embodiment of the invention.

FIG. 2B shows a view of the clamping mounts of the invention of FIG. 2A.

FIG. 3 is a perspective view of another embodiment of the invention.

FIG. 4 is a perspective view of another embodiment of the invention.

FIG. 5 is a perspective view of another embodiment of the invention.

FIG. 6A is a perspective view of another embodiment of the invention.

FIG. 6B is a side view of articulating or movable arm rests.

FIG. 7 is a side view of an embodiment of the invention demonstrating the ergonomic weight distribution advantages of the invention.

FIG. 8A is a side view of an embodiment of the invention demonstrating the ergonomic weight distribution advantages of the invention.

FIG. 8B is a side view of another embodiment of the invention.

FIG. 9 is a perspective view of the underside of an embodiment of the invention.

FIG. 10 shows an embodiment of the invention mounted on a bicycle.

FIG. 11 shows an embodiment of the invention mounted on a spin-cycle.

FIG. 12 shows an exploded view of an embodiment of the invention with an exercise ball.

FIG. 13 shows a perspective view of an embodiment of the invention with an exercise ball.

FIG. 14 shows the embodiment of FIG. 13 in use on a chair.

FIG. 15 shows the embodiment of FIG. 13 in use on a table.

### LIST OF NUMBERED COMPONENTS

110 Amenity platform
115 Amenity tray
116 Speaker
118 Speaker mounts
117 Amenity tray surface
119 Fan
120 Platform frame
121 Power receptacle
122 Clamp
123 Hinge
125 Device interface
126 Human form disposition element
127 Exercise device
130 Arm rest frame
135 Arm rest pad bar
137 Arm rest pad bar angle
140 Arm rest frame strut
142 Kneeling chair posture device
145 Arm rest pad
146 Seat rest
147 Knee rest
155 Frame interface
160 Platform frame bar
162 Platform frame bar angle
165 Platform frame base
167 Platform frame base u-section
170 Bracket
175 Platform clamp
180 Clamp half
185 Platform clamp aperture
187 Raised cross member clamp aperture
190 Bolt or screw
195 Yoke
200 Up-right
205 U-section
210 Bifurcation
215 Container
220 Vibrator
225 Pop up wedge
227 Kick stand
235 Raised cross member
237 Attachment
240 Stem
242 Stem aperture
244 Stop element
246 Ancillary device
248 Slot
250 Trough
252 User
254 User arm
256 User hand
258 Stem mating pieces
260 Bolts
262 Pedal
264 Generator
266 Sprocket
268 Belt
270 Ancillary device mount
272 Seat
274 Roller pad texture
276 Mount screw
278 Sliding tubes
279 Support bars
296 Cup or device holder or mount
400 Exercise ball or grip
420 Retractable line
420 Standalone arms
502 Computing device

### DETAILED DESCRIPTION OF EXEMPLARY EMBODIMENTS

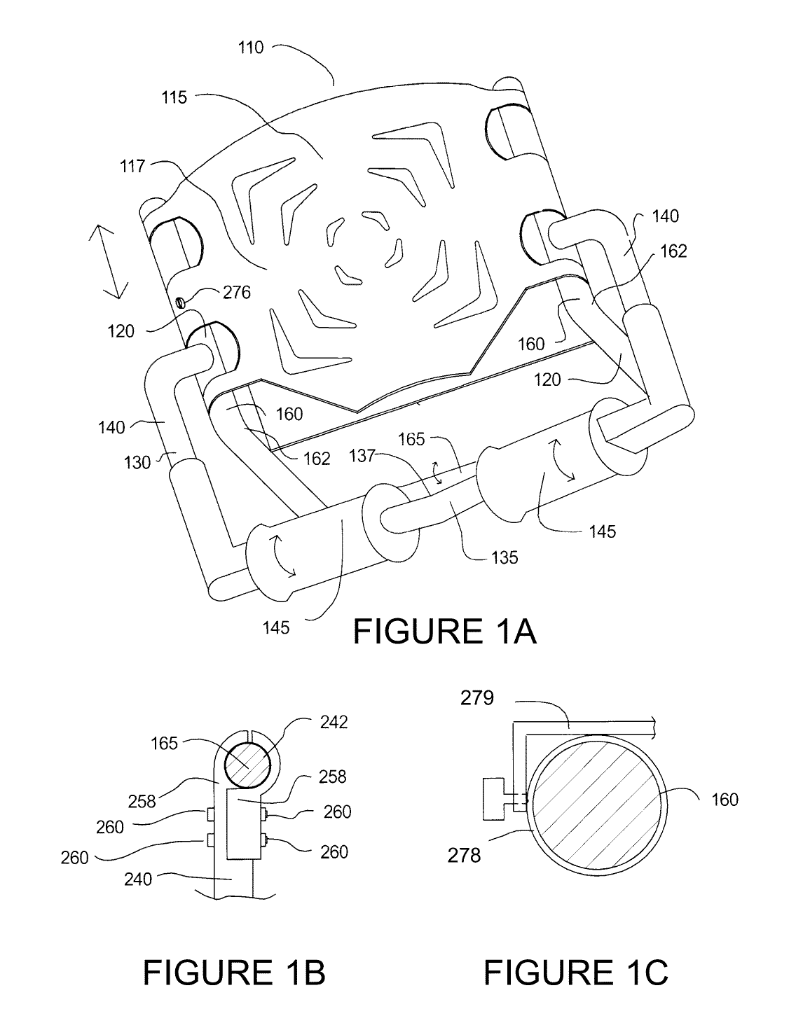

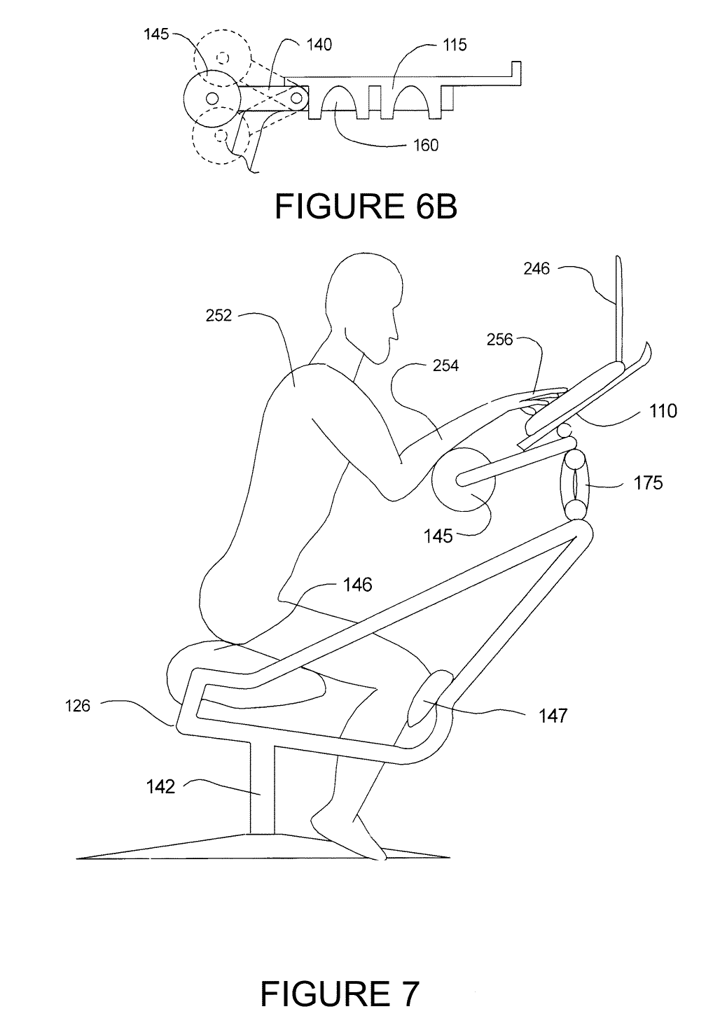

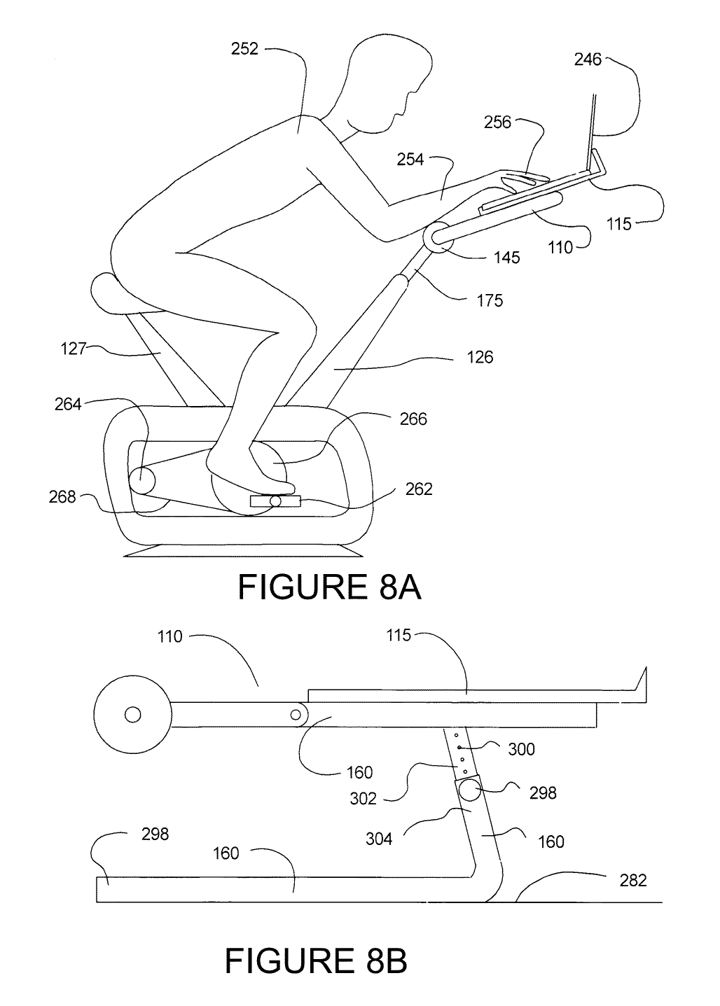

In one exemplary embodiment, as seen in FIG. 1, the present system provides a platform, which may also be referred to as an amenity platform (110), that may stand alone or be attached to a human form disposition element (126), as in FIG. 7, which may comprise, but not be limited to, an exercise device (127) as seen in FIG. 8. Said amenity platform (110), in one embodiment, comprises a platform frame (120) having an essentially u-shape with opposing, essentially parallel, bars (160) extending from opposite ends of a platform frame base (165).

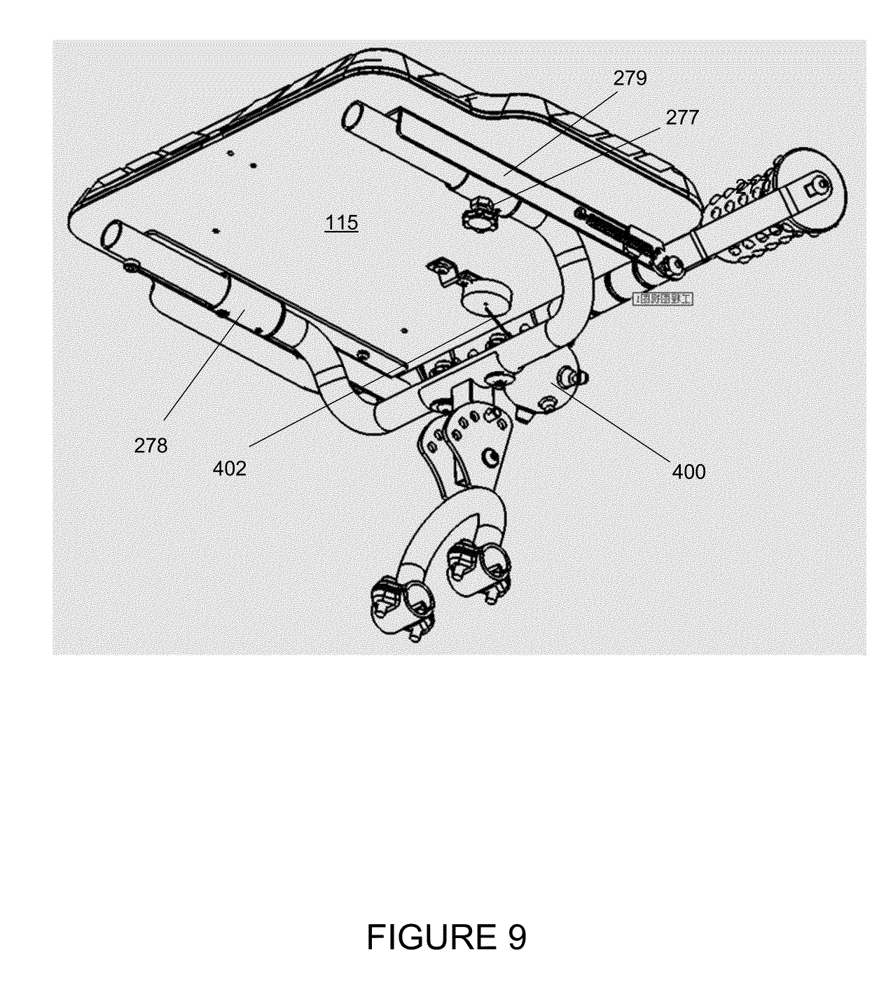

Oriented between the bars (160) and fixedly (such as by a mounting screw (276)) or removably attached thereto is an amenity tray (115) having a surface (117). In addition, the amenity tray (115) and surface (117) may be slideable relative the bars (160) as shown by double headed arrow. As seen in FIGS. 1C and 9, in one embodiment this is accomplished by two L-shaped support bars (279) attached to the underside of the tray (115), fastened in turn to sliding tubes (278) that fit over the platform frame bars (160). The sliding tubes slide up and down the frame bars, and can be fastened in place by a screw, bolt or similar means (277).

Also seen is an arm rest frame (130) comprising an arm rest pad bar (135) having opposing arm rest frame struts (140) extending essentially parallel from opposing ends of the arm rest pad bar (135). Additionally, proximal opposite ends of the arm rest pad bar (135) and fixedly, rotatably, or removably attached to said arm rest pad bar (135) are arm rest pads (145). Also, the arm rest frame struts (140) are fixedly or removably attached to the platform frame bars (160). Thus, the arm rest frame (130) is disposed such that the arm rest pad bar (135) and the arm rest pads (145) are positioned so that a user might place his forearms on the pads (145) so that said forearms extend toward the amenity tray (115) to such extent that said user's hands may access and/or manipulate items or devices placed on said amenity tray (115) while said user is actively, functionally engaged with said associated human form disposition element (126).

In addition, it will be readily appreciated that the user may move his forearms so as to extend his hands either toward or away from any device disposed on the amenity tray (115) while said forearms remain in contact with the arm rest pads (145), as seen in FIG. 7 and FIG. 8. In such instance, said forearms may slide over said pads (145) or said pads (145) may be caused to rotate, as shown by curved arrows in FIG. 1, by friction there between. The pads may be textured or pebbled (274) to enhance the massage effect. In either instance, massage of said forearms may be affected.

One familiar with the art will readily appreciate that the amenity platform (110) will further comprise means to fixedly or removably communicate with said human form disposition element (126), as in FIG. 7, in example an exercise device (127), as in FIG. 8, to dispose said platform (110) in operative position. Further, since exercise devices exist in sundry configurations, the amenity platform (110) will be embodied in different forms required to affect operative communication with said varying human form disposition devices. However, one skilled in the art can easily design interfaces so that the amenity platform (110) and sundry varieties of human form disposition elements may operatively communicate. Examples will be described presently.

When the amenity platform (110) is in operative position as previously described and shown in FIG. 7 and FIG. 8, the user (252) may place upon the amenity tray (115) ancillary devices (246), in example a laptop computer (502), smart phone, iPod, iPad, CD player, and the like, which he may use during exercise. Alternatively or additionally, the user (252) could exploit the amenity tray (115) to support other ancillary devices (246) such as video game controllers, mobile phones, books to read, clothes to fold, vegetables to chop, etc. Therefore, during exercise, the user (252) might distract, amuse, or edify himself while performing other useful or profitable tasks such as typing, processing documents, researching, investigating, etc. Thusly engaged, the user (252) will be distracted from his body's physical exertion and occasion for boredom will be eliminated causing the user to continue present exercise to sufficiently beneficial point and to be more willing, even eager, to initiate future sessions.

One familiar with the art will also readily appreciate that many exercise devices, such as bicycles or other pedal driven machines, may be tiresome to engage for long periods of time because they are configured so that the user must adapt non-ergonomic or tiresome posture whereby said user's upper body weight is disposed over said user's hands which are supported by an element such as handlebars. The strain, thusly caused, tends to tire out the hands, wrists, arms, shoulders, and neck encouraging said user to discontinue exercise before the lower body is sufficiently conditioned. However, the instant arm rest pads (145) are oriented such that upper body weight may be transferred to forearms, thusly providing alternatives to hand support and increasing the time said body elements may bear strain, as seen in FIG. 7 and FIG. 8.

It is widely known that exercise devices generally comprise means to engage the feet with elements to be moved by said feet and elements to engage the hands to facilitate balance and the ability of the user to maintain contact with the foot engagement means without falling off of or out of the device. Also, means to engage the hands are varied; therefore, means to functionally affix the amenity platform (110) to the exercise device must also be varied.

As an example, many exercise devices comprise handlebars having essentially a u-shape with handles at opposing ends. Said handlebars are generally affixed to the associated exercise device by means of a stem (240) having an aperture (242) which may be constricted around the handlebars passed there through thusly affecting a friction lock.

As shown in FIG. 1A, the typical stem (240) comprises mating pieces (258) which comprise the stem aperture (242). The mating pieces (258) are fitted around the platform frame base (165) thusly comprising the aperture (242) through which said platform frame base (165) passes. Bolts (260) passing through the mating pieces (258) may be tightened thusly forcing said mating pieces (258) together whereupon sufficient force is exerted on the platform frame base (165) to comprise a friction lock to fix the amenity platform (110) in one position.

Also, the aperture and the handlebars may comprise corresponding protrusions and depressions, in example knurls, to enhance the said locking FIG. 1 shows an amenity platform (110) configuration in which the platform frame base (165) could be passed through such an aperture, which when constricted, would hold said platform (110) in operative position. Also, it will be readily understood that when passed through said unrestricted aperture, the platform base (165) may be rotated, as shown by curved arrow, so that when said aperture is constricted, the base (165) may be fixed in one of sundry possible orientations.

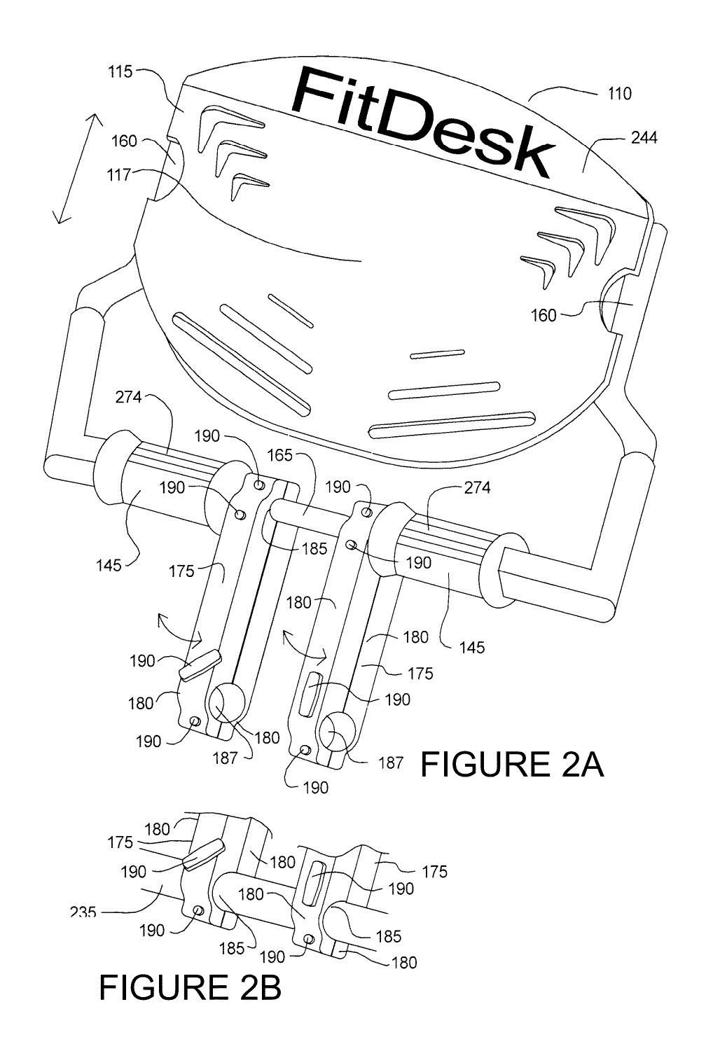

FIG. 2 shows an amenity platform (110) configuration wherein the amenity arm rest pads (145) are affixed to the platform frame base (165) and the amenity tray (115) is attached to the platform frame bars (160) and the arm rest frame (130) is eliminated. This amenity platform (110) may be attached to an exercise device having a raised cross member (235) in alternative to a stem (240) with an aperture by means of one or more elongated platform clamps (175). Said platform clamps (175), as in FIG. 2, may comprise clamp halves (180) which may be held together by bolts or screws (190). The platform clamps (175) comprise apertures (185) at opposite extremes.

Now it may be readily appreciated that the platform clamps (175) may be manipulated so that the platform frame base (165) passes through a platform clamp aperture (185) and the raised cross member (135) passes through the opposite platform clamp aperture (185). The bolts or screws (190) may then be tightened thusly constricting the apertures and immovably fixing the platform clamps (175), the raised cross member (235), and the platform frame base (165) by friction lock. It will be readily appreciated that the platform clamps (175) may be oriented relative elements passing through the platform clamp apertures (185) in sundry different positions and one of said many possible positions may be fixed when the bolts or screws (190) are tightened. Thus the platform frame (120), the platform clamps (175), and the raised cross member (235) may be articulated relative each other.

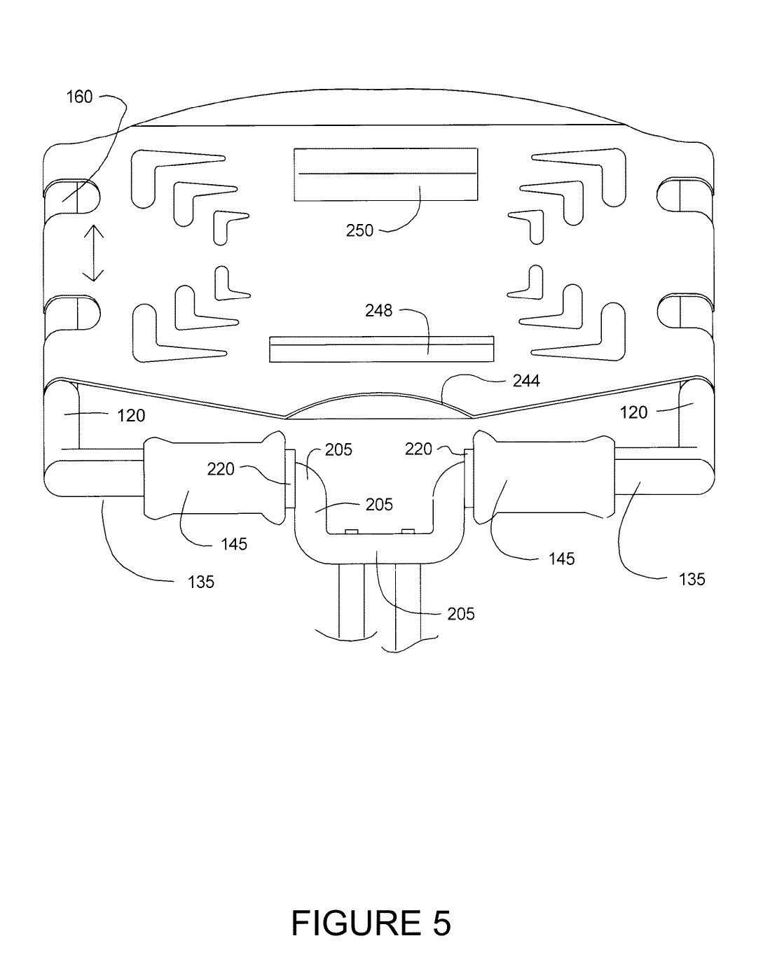

Also, as seen in FIG. 2 and FIG. 5, the amenity platform (110) may have one or more stop elements (244) extending from the amenity tray surface (117) to limit movement of any item placed on said surface (117) so that said item will be prevented from falling off the amenity tray (115).

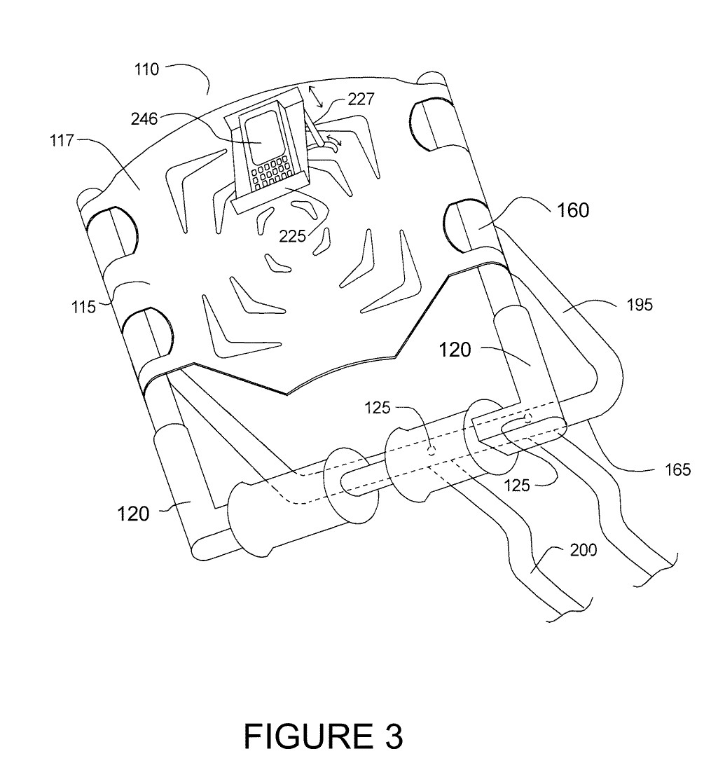

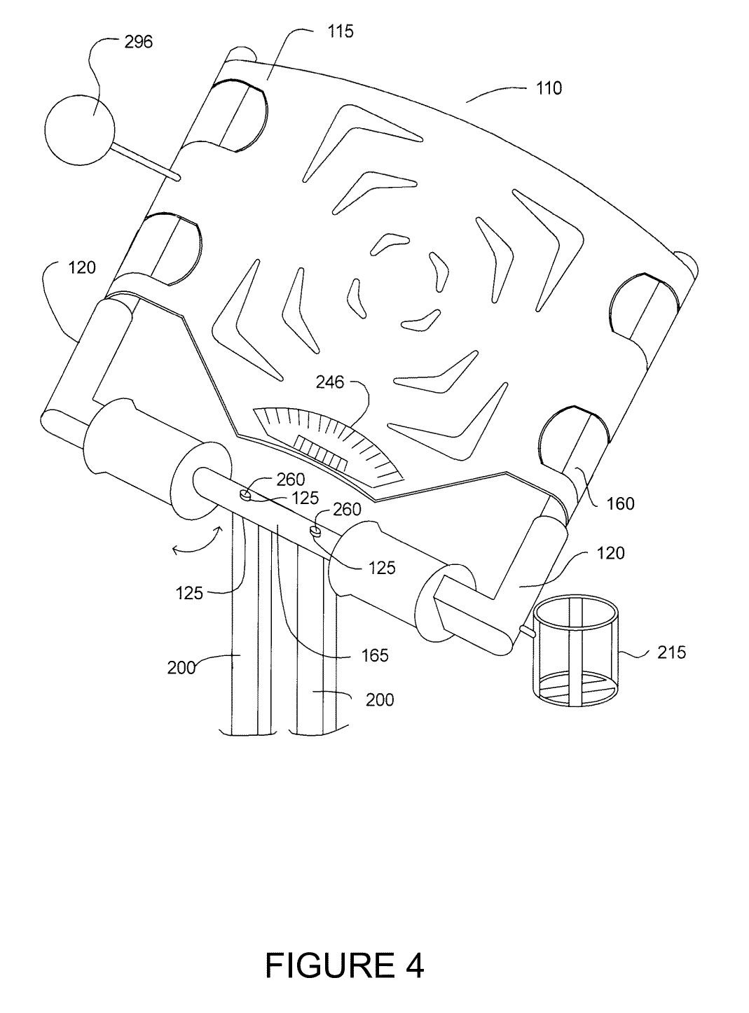

FIG. 3 and FIG. 4 show that the amenity platform (110) comprising platform frame (120) with platform frame base (165) and platform frame bars (160) may interface (125) with uprights (200) extending from an exercise device by means of a yoke (195) attached to said uprights (200) and the platform frame bars (160). FIG. 3 additionally shows that the amenity tray surface (117) may comprise a pop-up wedge (225) which may be raised and lowered, as indicated by double headed curved arrow, and that said pop-up wedge may be held in a variety of positions by a kick stand (227) which is movable relative the wedge (225) as indicated by double headed curved arrow. Said wedge (225) may support in operative position accessible by a user any of sundry devices such as smart phones, iPods, and the like.

FIG. 4 shows that the amenity platform (110) comprising platform frame (120) with platform frame base (165) and platform frame bars (160) may be attached directly to exercise device uprights (200) by interface (125) with the platform frame base (165). Said interface may comprise bolts (260) or any other connective means easily contrived by one skilled in the art. Also noted is that the arm pads (145) are rotatable relative the platform frame base as indicated by double headed curved arrows.

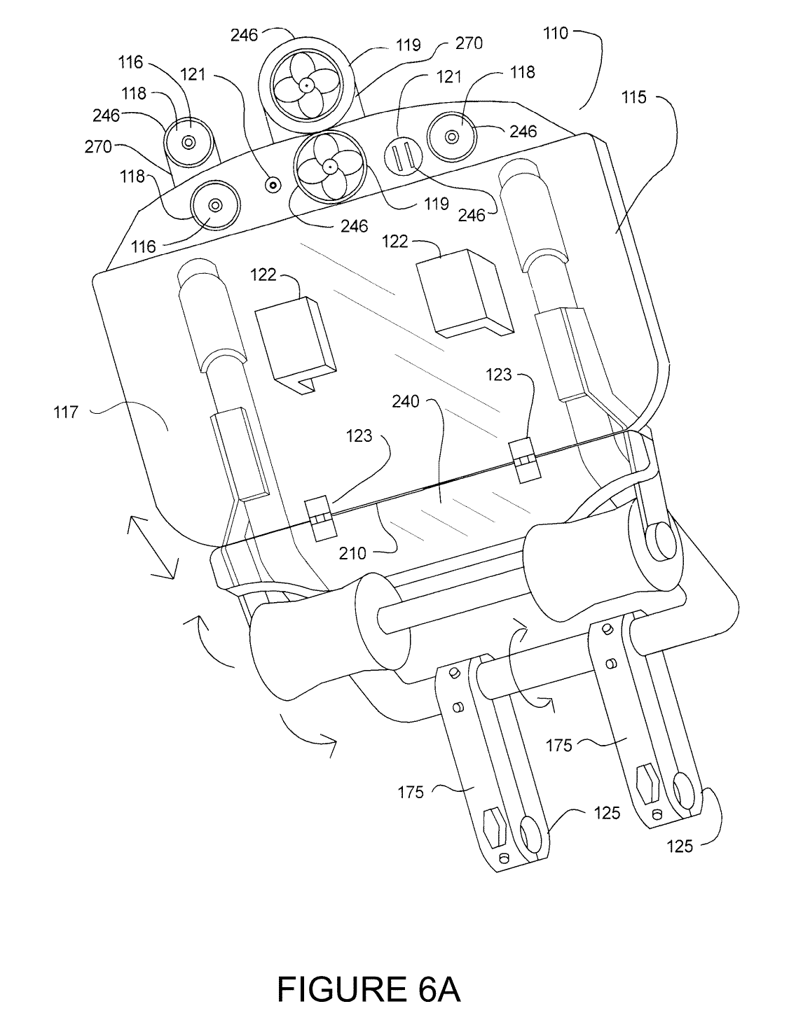

One skilled in the art will readily appreciate that particular elements of the amenity platform (110) may comprise particular configurations in order to enhance effectiveness thereof. For example, FIG. 1 shows that the platform frame bars (160) may comprise angles (162) and that the arm rest pad bar (135) may comprise an angle (137) and FIG. 5 shows that the platform frame base (165) may comprise a u-section (205) which may be attached directly to elements of an exercise device. FIG. 6 shows that the amenity tray (115) may comprise bifurcation (210) and hinge (123) and that resultant sections (240) may articulate one relative the other as indicated by arrows and double headed arrow. Also shown in FIG. 4 is that the amenity platform (110) may comprise one or more containers (215) for a cup, cell phone, or other convenient device.

FIG. 6 additionally shows that the amenity tray (115) may comprise means and configurations to fix devices thereto, in example, one or more clamp devices (122). Also seen is that the amenity platform may comprise such devices as fan (119), speaker mounts (118) with speakers (116), or power receptacle (121). Said devices may be integral to the amenity tray (115) or they may be attached to the amenity platform (110) by mounts (270). Said devices may be removable. It will also be understood that sundry elements of the amenity platform (110) and means of interface (125) with exercise devices will comprise means, in example the afore-described friction locks, to adjust the orientations of particular elements according to the best judgment of one skilled in the art. In example, said elements may be contrived to affect ergonomic benefits or to allow visual and/or manual access to elements of the exercise device such as heart rate and blood pressure monitors, calorie consumption displays, timers, equivalent travel distance indicators, speedometers, and the like.

Additionally, it will be readily appreciated that that the exercise device may comprise power generation means to energize devices supported by the amenity platform (110). In example, FIG. 8 shows the amenity platform (110) oriented relative to an exercise device such that the user (252) may assume an ergonomic posture with weight supported by a seat (272) and an arm rest pad (145). Also seen is that the user's arm (254) may be positioned on the arm rest pad (145) so that his hands (256) may access a device supported by the amenity platform (110).

FIG. 8 also shows the user (252) operatively communicating with an exercise device by means of pedals (262). Now it will be readily appreciated that such exercise devices having elements set in motion by human interface may comprise electric generation means. In one exemplary embodiment, as seen in FIG. 8, the pedals (262) may turn a sprocket (266) which communicates with a generator (264) by means of belt (268). Thus electricity to power ancillary devices (246) may be provided. It will be readily appreciated that said electricity may be transmitted to said devices (246) by means of wires (not shown).

FIG. 7 shows the healthy ergonomic weight distribution possible when combining this invention (110) with the well-known principle of a “kneeling chair” posture device (142) having a seat rest (146) and a knee rest (147).

Using this combination, a totally new working environment is created which permits the user to distribute his or her weight over three widely separated points while providing the added advantage of forearm massage where the arms rest on the arm pad rollers (145). This not only reduces the weight applied to the spine, buttocks, and knees, but also helps to decrease risk of carpel tunnel syndrome by providing massage therapy for the forearms.

In another exemplary embodiment, as seen in FIG. 5, the arm rest pads (145) may comprise vibrators (220) or other massage devices. Also shown is that the amenity tray (115) is slideable relative the platform frame bars (160) as indicated by double headed arrow. FIG. 5 also shows that the amenity tray (115) may comprise slots (248) or troughs (250) to support or confine ancillary devices (246).

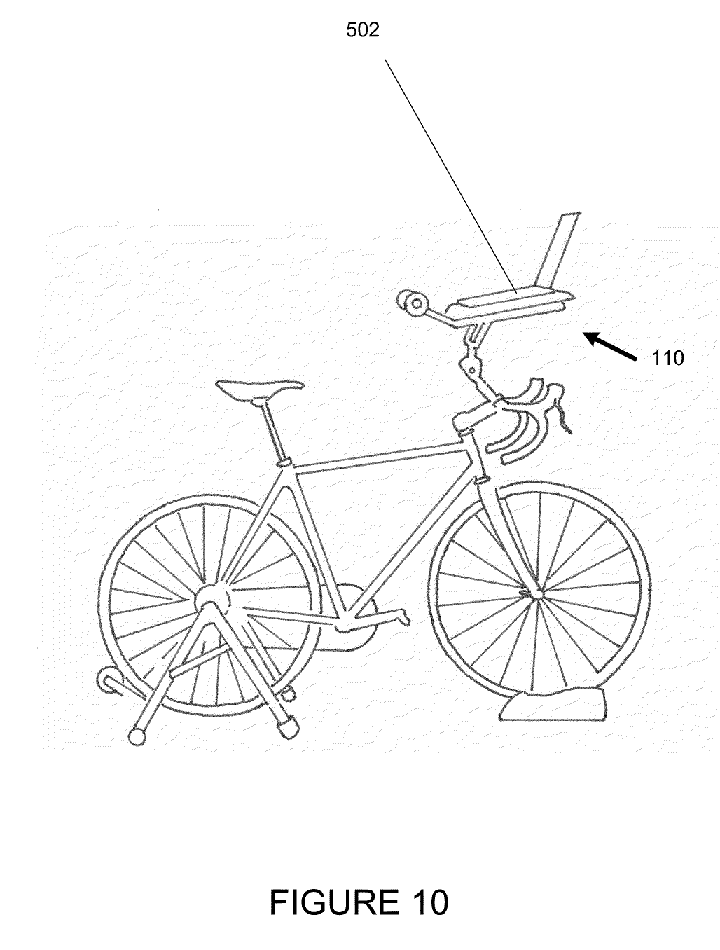

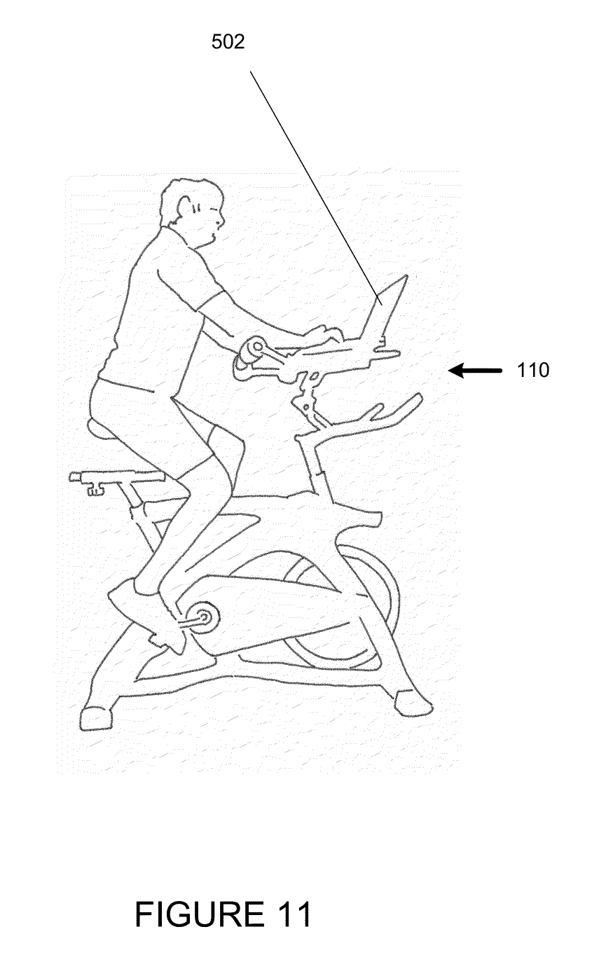

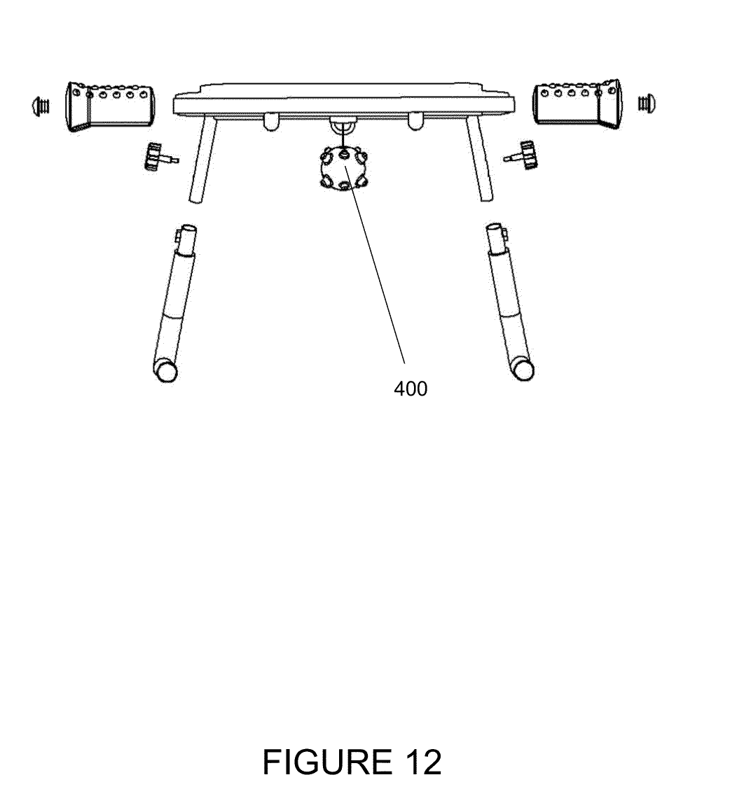

In yet another embodiment, the grips may be squeezable to provide hand exercise. Alternatively, or in addition, one or more hand exercisers or squeeze/syringe balls (400) or grips may be provided on the top or underside of the apparatus. In one embodiment, said hand exercise or balls or grips may be attached to the apparatus via a retractable line (402), as seen in FIGS. 9-12.

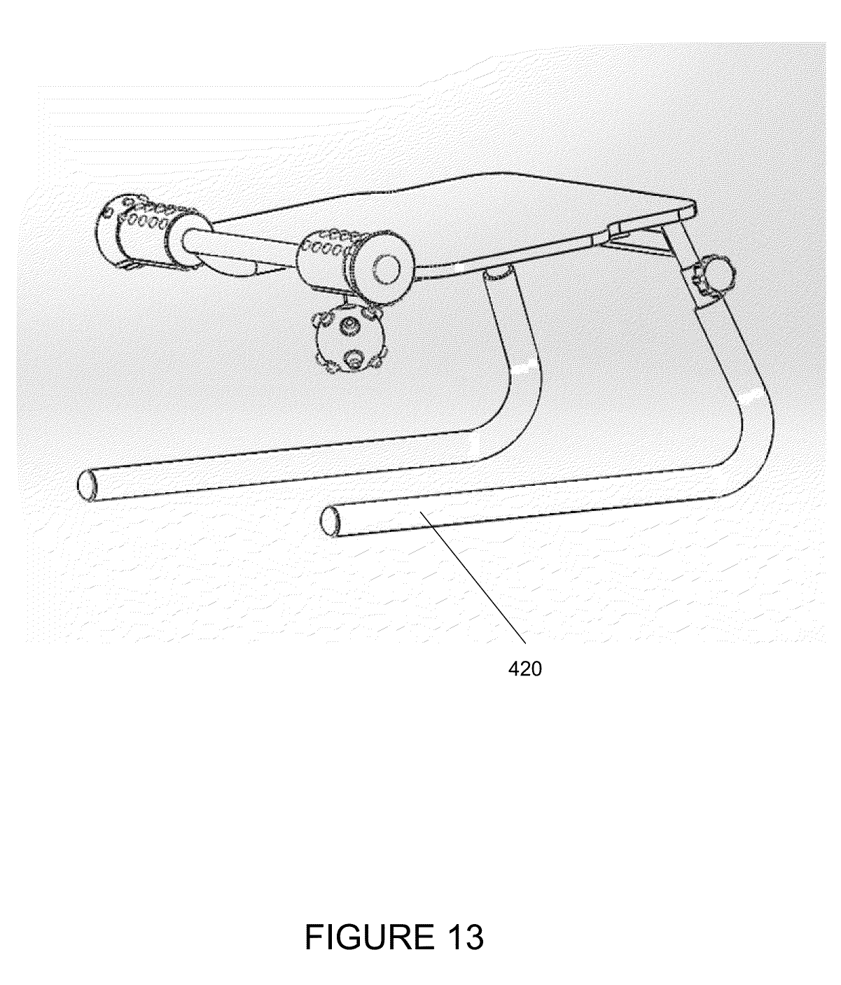

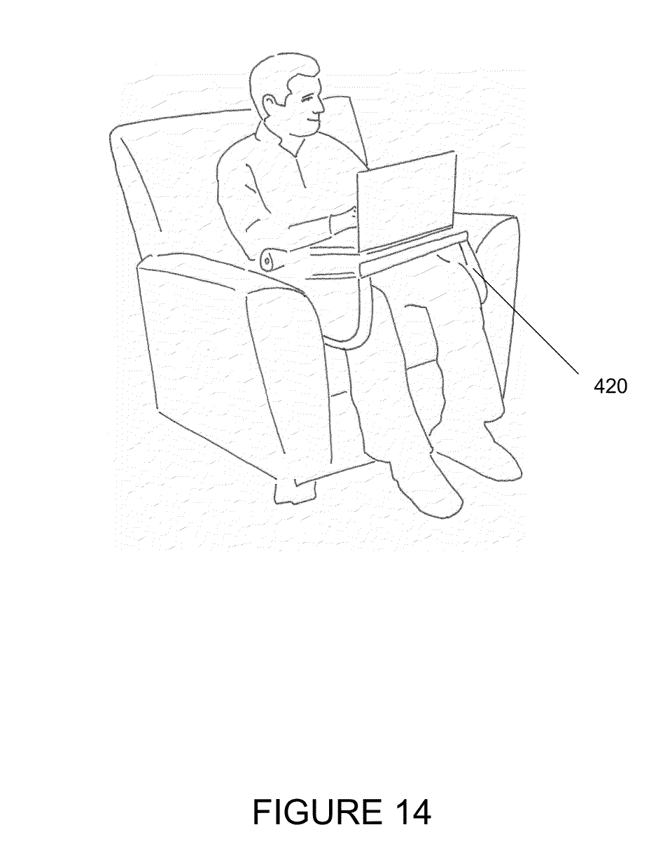

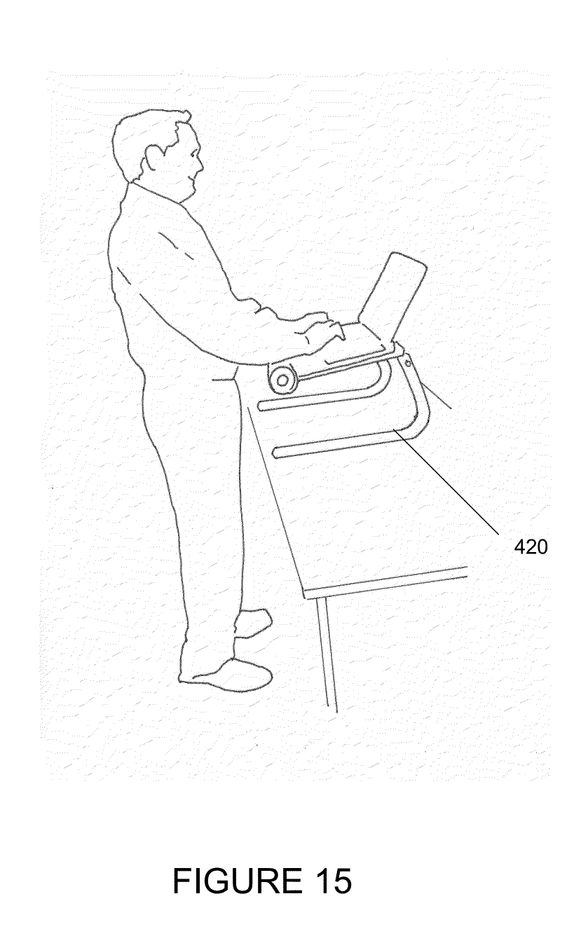

In yet a further embodiment, as seen in FIG. 13-15, the support arms are stand-alone support arms (420) adapted to rest on a flat surface, such as the seat of a chair, the arms of a chair, a floor, or a desk-top. The apparatus of the present invention can thus be used in a easily portable, convenient manner in a variety of locations and positions.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for supporting devices, comprising:
a platform or tray connected to one or more support arms or mounts; and
one or more movable or articulating arm or wrist rests attached to the platform or tray.

2. The apparatus of claim 1, wherein the support arm is attached to the bottom of the platform or tray.

3. The apparatus of claim 1, wherein the platform or tray is attached to a human form disposition element.

4. The apparatus of claim 1, wherein the human form disposition elements comprises an exercise machine.

5. A platform capable of supporting devices accessed by hands of a person while functionally engaged with a human form disposition element including, but not limited to a chair or an exercise device, said platform comprising:
an amenity tray attached to said human form disposition element; and
one or more arm rests attached to the amenity tray.

6. The platform of claim 5, wherein the amenity tray comprises a tray frame.

7. The platform of claim 5, wherein the arm rest comprises pads, and an arm rest frame.

8. The platform of claim 7, wherein the arm rest frame is in communication with a tray frame.

9. The platform of claim 8, wherein the arm rest frame articulates relative to the tray frame.

10. The platform of claim 5, wherein the amenity tray comprises sections which can articulate relative to each other.

11. The platform of claim 5, further comprising at least one instrument container or receptacle.

12. The platform of claim 5, wherein the armrest comprises a vibrating or massaging device.

13. The platform of claim 5, wherein the human form disposition element comprises electrical power production means.

14. The platform of claim 5, wherein the amenity tray is attached to the human form disposition element by one or more arms permitting articulated communication between the amenity tray and the human form disposition element.

15. The platform of claim 5, wherein the amenity tray comprises an adjustable wedge device, said wedge device capable of supporting an object resting on, or mounted on, said tray.

16. The platform of claim 5, wherein the one or more arm rests are capable of rotating in a plane in such a manner as to accomplish a massage function.

17. The platform of claim 5, wherein the one or more arm rests are capable of supporting a user's weight applied to the user's arms in communication with said arm pads.

18. The platform of claim 5, wherein the amenity tray is slidably attached to an arm rest frame or a platform frame.

19. The platform of claim 5, further comprising one or more of speakers, speaker mounts, a fan, or a power receptacle on the amenity tray.
